(19) United States
(12) Patent Application Publication
(10) Pub. No.: US 2026/0237689 A1
(43) Pub. Date: Aug. 13, 2026

(54) COMPOSITE FUEL CELL BIPOLAR PLATE

(71) Applicant: GM GLOBAL TECHNOLOGY OPERATIONS LLC, Detroit, MI (US)

(72) Inventors: Swaminatha P. Kumaraguru, Rochester Hills, MI (US); Tara Sengupta, Royal Oak, MI (US); Jeremy William Dabel, Oxford, MI (US)

(73) Assignee: GM GLOBAL TECHNOLOGY OPERATIONS LLC, Detroit, MI (US)

(21) Appl. No.: 19/051,485

(22) Filed: Feb. 12, 2025

(51) Int. Cl. H01M 8/0258; H01M 8/0213; H01M 8/0221; H01M 8/0226; H01M 8/0267; H01M 8/1004; H01M 16/00

(52) U.S. Cl. CPC H01M 8/0258; H01M 8/0213; H01M 8/0221; H01M 8/0226; H01M 8/0267; H01M 8/1004; H01M 16/006; H01M 2220/20; H01M 2250/20

(57) ABSTRACT

Fuel cells, devices, and methods for forming fuel cells are provided. A fuel cell includes first and second MEAs; a plate assembly including a first composite sub-plate including first lands located against the first MEA anode side; first protrusions distanced from the first MEA anode side; and first ribs interconnecting the first lands and first protrusions; and a second composite sub-plate including second lands located against the first lands; second protrusions located against the second MEA cathode side; and second ribs interconnecting the second lands and second protrusions; wherein flow channels open to the first MEA anode side are defined between the first MEA and first protrusions; wherein flow channels open to the second MEA cathode side are defined between the second MEA and second lands; and wherein the first and second composite sub-plates are nested together to form coolant flow channels between the first lands and second protrusions.

### INTRODUCTION

The technical field relates generally to proton-exchange membrane (PEM) fuel cells, and more particularly to bipolar plates separating adjacent fuel cells in a fuel cell stack.

Fuel cells have been used as a power source in many applications. For example, fuel cells have been proposed for use in electrical vehicular power plants to replace internal combustion engines. In proton exchange membrane type fuel cells, hydrogen is supplied to the anode of the fuel cell and oxygen is supplied as the oxidant to the cathode. The oxygen can be either a pure form (O₂) or air (a mixture of O₂ and N₂). Proton exchange membrane fuel cells include a membrane electrode assembly (MEA) including a thin, proton transmissive, non-electrically conductive, solid polymer electrolyte membrane having the anode catalyst on one face and the cathode catalyst on the opposite face.

The membrane electrode assembly is sandwiched between a pair of non-porous, electrically conductive elements or plates which pass electrons from the anode of one fuel cell to the cathode of the adjacent cell of a fuel cell stack; contain appropriate channels and/or openings formed therein for distributing the fuel cell's gaseous reactants over the surfaces of the respective anode and cathode catalysts; and contain appropriate channels and/or openings formed therein for distributing appropriate coolant throughout the fuel cell stack in order to maintain temperature.

The electrically conductive plates sandwiching the membrane electrode assemblies may contain an array of grooves in the faces thereof that define a reactant flow field for distributing the fuel cell's gaseous reactants (i.e., hydrogen and oxygen in the form of air) over the surfaces of the respective anode and cathode. These reactant flow fields generally include a plurality of lands that define a plurality of flow channels therebetween through which the gaseous reactants flow from a supply header at one end of the flow channels to an exhaust header at the opposite end of the flow channels.

The term “fuel cell” is typically used to refer to either a single cell or a plurality of cells (stack) depending on the context. A plurality of individual cells are typically bundled together to form a fuel cell stack and are commonly arranged in electrical series. Each cell within the stack includes the membrane electrode assembly described earlier, and each such membrane electrode assembly provides its increment of voltage.

In a fuel cell stack, a plurality of cells are stacked together in electrical series while being separated by a gas impermeable, electrically conductive bipolar plate. In some instances, the bipolar plate is an assembly formed by securing a pair of thin metal sheets having reactant flow fields formed on their external face surfaces. Use of thin metal sheets enable a thin bipolar plate assembly with total thickness of 0.7 mm or higher. High volumetric power density has been achieved. However, metal bipolar plates, specifically those made from stainless steel, tend to corrode and release iron ions, significantly reducing the performance and durability of membranes and fuel cells.

It would be desirable to provide non-metallic composite bipolar plates and methods for fabricating non-metallic composite bipolar plates. Furthermore, other desirable features and characteristics of the present disclosure will become apparent from the subsequent detailed description and the appended claims, taken in conjunction with the accompanying drawings and the foregoing introduction.

### SUMMARY

In one embodiment, a fuel cell includes a first membrane electrode assembly (MEA) and a second membrane electrode assembly (MEA), wherein each MEA has an anode side and a cathode side; a bipolar composite plate assembly located between the anode side of the first MEA and the cathode side of the second MEA, the bipolar composite plate assembly including: a first composite sub-plate including: first lands located against the anode side of the first MEA; first protrusions located at a distance from the anode side of the first MEA; and first ribs interconnecting the first lands and first protrusions; wherein first flow channels open to the anode side of the first MEA are defined between the first MEA and the first protrusions; and a second composite sub-plate including: second lands located against the first lands; second protrusions located against the cathode side of the second MEA; and second ribs interconnecting the second lands and second protrusions; wherein second flow channels open to the cathode side of the second MEA are defined between the second MEA and the second lands; and wherein the first composite sub-plate and the second composite sub-plate are nested together to form coolant flow channels between the first lands and the second protrusions.

In certain embodiments of the fuel cell, each composite sub-plate has a web thickness of from 0.1 mm to 0.4 mm.

In certain embodiments of the fuel cell, each composite sub-plate is formed from carbon and resin and is compression molded.

In certain embodiments of the fuel cell, each composite sub-plate is formed from a flexible graphite material molded and filled with resin.

In certain embodiments of the fuel cell, each composite sub-plate is reinforced with conductive carbon fibers.

In certain embodiments of the fuel cell, the bipolar composite plate assembly forms a flow field having a first edge facing headers for flowing hydrogen, oxygen, and/or coolant and having a second edge sealed to a frame; and an aspect ratio of the first edge to the second edge is from 0.8 to 4.0.

In certain embodiments of the fuel cell, the second protrusions include primary second protrusions alternating with secondary second protrusions; the coolant flow channels are defined between the first lands and the primary second protrusions; and the first flow channels are defined between the first MEA and the secondary second protrusions.

In certain embodiments of the fuel cell, the bipolar composite plate assembly extends in a lateral direction; and the primary second protrusions and the secondary second protrusions have a same second length in the lateral direction.

In certain embodiments of the fuel cell, the first composite sub-plate has a first repeating pattern of first lands, first protrusions, and first ribs; the first repeating pattern has a first period; the second composite sub-plate has a second repeating pattern of second lands, second protrusions, and second ribs; the second repeating pattern has a second period; and the second period is equal to half of the first period.

In certain embodiments of the fuel cell, the first protrusions are located between the first MEA and the secondary second protrusions; and the first protrusions are spaced from and do not contact the secondary second protrusions.

In certain embodiments of the fuel cell, the first ribs are spaced from and do not contact the second ribs.

In certain embodiments of the fuel cell, the first composite sub-plate and the second composite sub-plate contact each other at contact interfaces; and the contact interfaces are only located between the first lands and the second lands.

In certain embodiments of the fuel cell, the first protrusions have a first length in the lateral direction; the first protrusions are located between the first MEA and the secondary second protrusions; and the first protrusions contact the secondary second protrusions along an entirety of the first length.

In certain embodiments of the fuel cell, the first ribs include primary first ribs and secondary first ribs alternating with the primary first ribs; the primary first ribs contact the second ribs; and the secondary first ribs are spaced from and do not contact the second ribs.

In certain embodiments of the fuel cell, the first composite sub-plate has a first repeating pattern of first lands, first protrusions, and first ribs; the first repeating pattern has a first period; the second composite sub-plate has a second repeating pattern of second lands, second protrusions, and second ribs; the second repeating pattern has a second period; and the second period is equal to the first period.

In certain embodiments of the fuel cell, the bipolar composite plate assembly extends in a lateral direction; the first protrusions have a first length in the lateral direction; the first protrusions are located between the first MEA and the second protrusions; and the first protrusions contact the second protrusions along an entirety of the first length.

In certain embodiments of the fuel cell, the first ribs include primary first ribs and secondary first ribs alternating with the primary first ribs; the primary first ribs contact the second ribs; the secondary first ribs are spaced from and do not contact the second ribs; and each coolant flow channel is defined between a respective secondary first rib and a respective second rib.

In another embodiments, a device is provided and includes a battery configured to store electricity; and a fuel cell electrically connected to the battery, wherein the fuel cell includes: a first membrane electrode assembly (MEA) and a second membrane electrode assembly (MEA), wherein each MEA has an anode side and a cathode side; a bipolar composite plate assembly located between the anode side of the first MEA and the cathode side of the second MEA, the bipolar composite plate assembly including: a first composite sub-plate including: first lands located against the anode side of the first MEA; first protrusions located at a distance from the anode side of the first MEA; and first ribs interconnecting the first lands and first protrusions; and a second composite sub-plate including: second lands located against the first lands; second protrusions located against the cathode side of the second MEA; and second ribs interconnecting the second lands and second protrusions; wherein: each composite sub-plate has a web thickness of from 0.1 mm to 0.4 mm; the first composite sub-plate and the second composite sub-plate are nested together to form coolant flow channels between the first lands and the second protrusions; first flow channels open to the anode side of the first MEA are defined between the first MEA and the first protrusions; second flow channels open to the cathode side of the second MEA are defined between the second MEA and the second lands; and the first composite sub-plate has a first repeating pattern of first lands, first protrusions, and first ribs; the first repeating pattern has a first period; the second composite sub-plate has a second repeating pattern of second lands, second protrusions, and second ribs; the second repeating pattern has a second period; and the second period is equal to half of the first period.

In certain embodiments, the device is a vehicle.

In certain embodiments of the device, the bipolar composite plate assembly forms a flow field having a first edge facing headers for flowing hydrogen, oxygen, and/or coolant and having a second edge sealed to a frame; and an aspect ratio of the first edge to the second edge is from 0.8 to 4.0.

In another embodiment, a method for forming a fuel cell includes providing a first membrane electrode assembly (MEA) and a second membrane electrode assembly (MEA), wherein each MEA has an anode side and a cathode side; and forming a bipolar composite plate from a first composite sub-plate and a second composite sub-plate, wherein the first composite sub-plate includes first lands, first protrusions, and first ribs interconnecting the first lands and first protrusions, and wherein the second composite sub-plate includes second lands, second protrusions, and second ribs interconnecting the second lands and second protrusions, by nesting together the first composite sub-plate and the second composite sub-plate to form coolant flow channels between the first lands and the second protrusions, to locate the first lands located against the anode side of the first MEA, to locate the first protrusions at a distance from the anode side of the first MEA, to locate the second lands against the first lands, to locate the second protrusions against the cathode side of the second MEA, to define first flow channels open to the anode side of the first MEA between the first MEA and the first protrusions, and to define second flow channels open to the cathode side of the second MEA between the second MEA and the second lands.

### DESCRIPTION OF THE DRAWINGS

The present disclosure will hereinafter be described in conjunction with the following drawing figures, wherein like numerals denote like elements, and wherein:

FIG. 1 is a schematic isometric exploded illustration of a PEM fuel stack incorporating a bipolar plate assembly in accordance with certain embodiments herein;

FIG. 2 is a plan view of a bipolar plate assembly used within the fuel cell of FIG. 1 in accordance with certain embodiments herein;

FIG. 3 is a partial cross-sectional view of a bipolar plate assembly located against the sides of adjacent membrane electrode assemblies in accordance with certain embodiments herein;

FIG. 4 is a partial cross-sectional view of a bipolar plate assembly located against the sides of adjacent membrane electrode assemblies in accordance with certain embodiments herein;

FIG. 5 is a partial cross-sectional view of a bipolar plate assembly located against the sides of adjacent membrane electrode assemblies in accordance with certain embodiments herein; and

FIG. 6 is a schematic illustrating a device including a fuel stack, in accordance with certain embodiments herein.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description. As used herein, the term module refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of automated driving systems including cruise control systems, automated driver assistance systems and autonomous driving systems, and that the vehicle system described herein is merely one example embodiment of the present disclosure.

Finally, for the sake of brevity, conventional techniques and components related to vehicle mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment. It should also be understood that the figures are merely illustrative and may not be drawn to scale.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

An exemplary composite fuel cell bipolar plate and a method for manufacturing a composite fuel cell bipolar plate are provided.

Typical composite plates are 1.5 mm thick, almost twice the thickness of metal bipolar plates. Embodiments herein reduce the overall thickness of composite bipolar plates to achieve volumetric power density comparable to metal bipolar plates. Further, composite bipolar plates are much lighter than metal bipolar plates, leading to higher gravimetric power density compared to metallic plates.

Certain embodiments utilize a nested design for mating the anode half plate or sub-plate with the cathode half plate or sub-plate. The nested design provides for reducing the plate thickness of a composite fuel cell bipolar plate, such as to about 0.75 mm. Further, the nested design adds mechanical robustness to the composite plate. Specifically, the nested configuration increases the mechanical strength of the bipolar plate assembly.

In certain embodiments, the aspect ratio of the composite plate is from 0.8 to 4.0 to reduce the pressure drop in the coolant due to reduced coolant flow. Specifically, as compared to existing plates, the coolant flow channel is shortened and more coolant flow channels are provided. The aspect ratio of the plate is used to reduce a potential increase in pressure drop.

In certain embodiments, the inactive region with headers is optimized to accommodate the aspect ratio.

Embodiments herein may provide a greater volumetric power density as compared to existing non-metallic bipolar plates.

In the nested concept, the anode land channel design includes relatively wide lands and relatively narrow channels. For example, the anode land is wide enough to nest into every other cathode land enabling a coolant path.

In certain embodiments, each half plate is made from half plate material of advanced composites that are reinforced with carbon fibers. Bipolar plates made from composite material half plates may avoid iron release, aiding in longevity; provide a relatively high gravimetric power density; and are lower cost, as compared to metal plates.

In certain embodiments, the half plate has a web thickness of from 0.1 mm to 0.4 mm before embossing, and from 0.5 to 0.9 mm post embossing. The final plate thickness, including two bipolar plates, is from 0.6 to 1.2 mm. In certain embodiments, the half plate has a web thickness of at least 0.1 mm, such as at least 0.15 mm, at least 0.2 mm, at least 0.25 mm, at least 0.3 mm, at least 0.35 mm, at least 0.4 mm, at least 0.45 mm, at least 0.5 mm, at least 0.55 mm, at least 0.6 mm, at least 0.65 mm, at least 0.7 mm, at least 0.75 mm, at least 0.8 mm, or at least 0.85 mm, and at most 0.9 mm, such as at most 0.85 mm, at most 0.8 mm, at most 0.75 mm, at most 0.7 mm, at most 0.65 mm, at most 0.6 mm, at most 0.55 mm, at most 0.5 mm, at most 0.45 mm, at most 0.4 mm, at most 0.35 mm, at most 0.3 mm, at most 0.25 mm, or at most 0.2 mm.

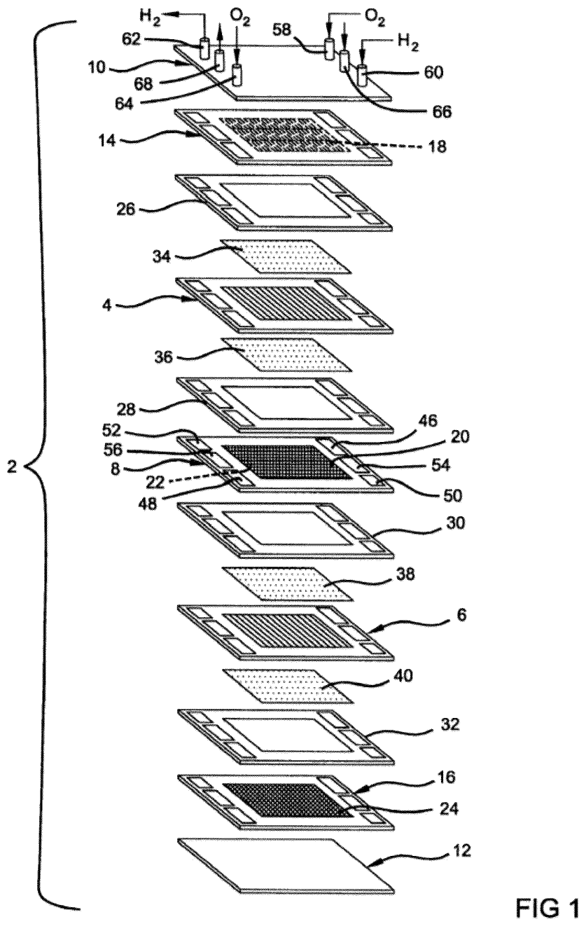

With reference to FIG. 1, certain features of a generalized bipolar plate stack are illustrated. In FIG. 1, a two-cell stack (i.e., one bipolar plate) is illustrated and described hereafter, it being understood that a typical stack will have many more such cells and bipolar plates. FIG. 1 depicts a two-cell bipolar PEM fuel cell stack 2 having a pair of membrane-electrode-assemblies (MEAs) 4 and 6 separated from each other by an electrically conductive, liquid-cooled bipolar plate 8 or bipolar plate assembly 8. The MEAs 4 and 6 and the bipolar plate 8 are stacked together between clamping plates 10 and 12 and monopolar end plates 14 and 16. The clamping plates 10 and 12 are electrically insulated from the ends plate 14 and 16. The working face of each monopolar end plates 14 and 16, as well as both working faces of the bipolar plate 8 contain a plurality of grooves or channels 18, 20, 22 and 24 defining a so-called “flow field” for distributing fuel and oxidant gases (i.e., H₂ and O₂) over the faces of the MEAs 4 and 6. Nonconductive gaskets 26, 28, 30 and 32 provide seals and electrical insulation between the several components of the fuel cell stack. Gas-permeable diffusion media 34, 36, 38, and 40 press up against the electrode faces of the MEAs 4 and 6. The end plates 14 and 16 press up against the diffusion media 34 and 40 respectfully, while the bipolar plate 8 presses up against the diffusion media 36 on the anode face of MEA 4, and against the diffusion media 38 on the cathode face of MEA 6.

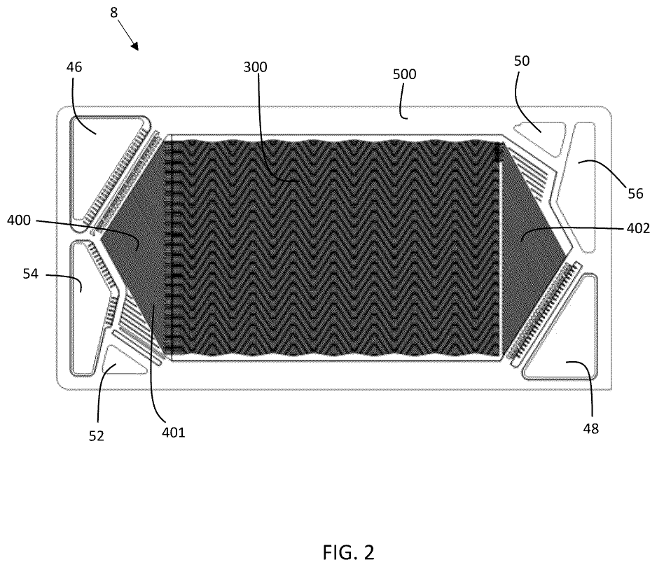

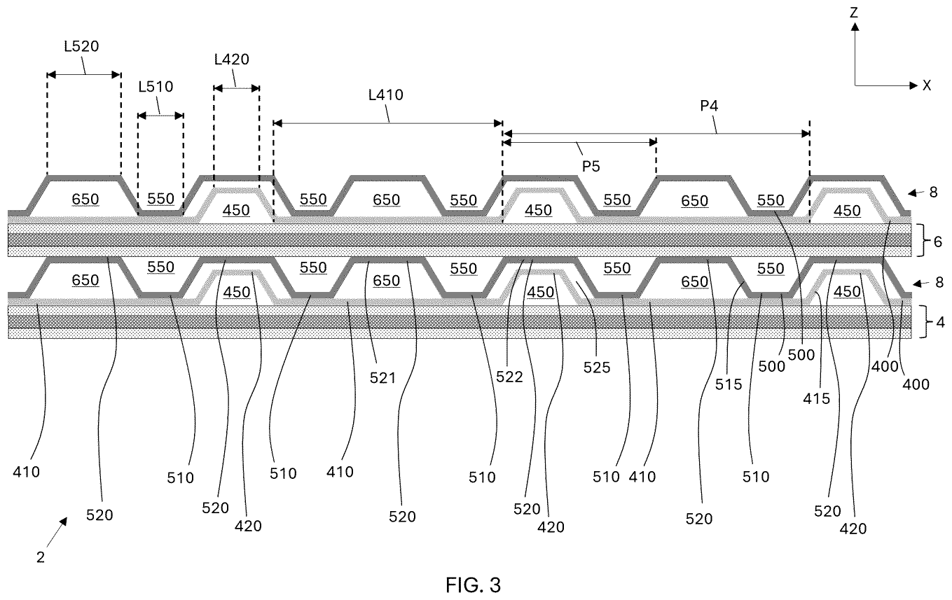

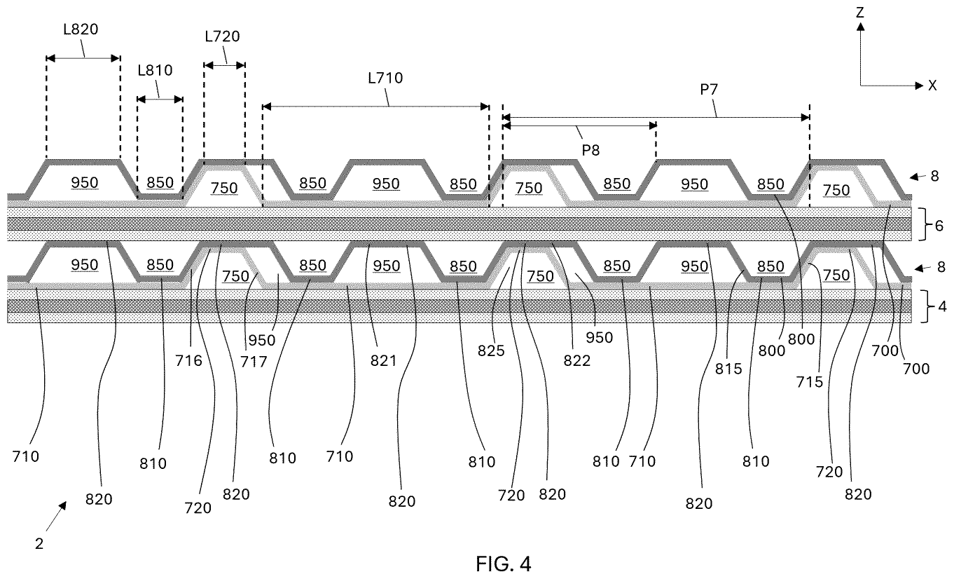

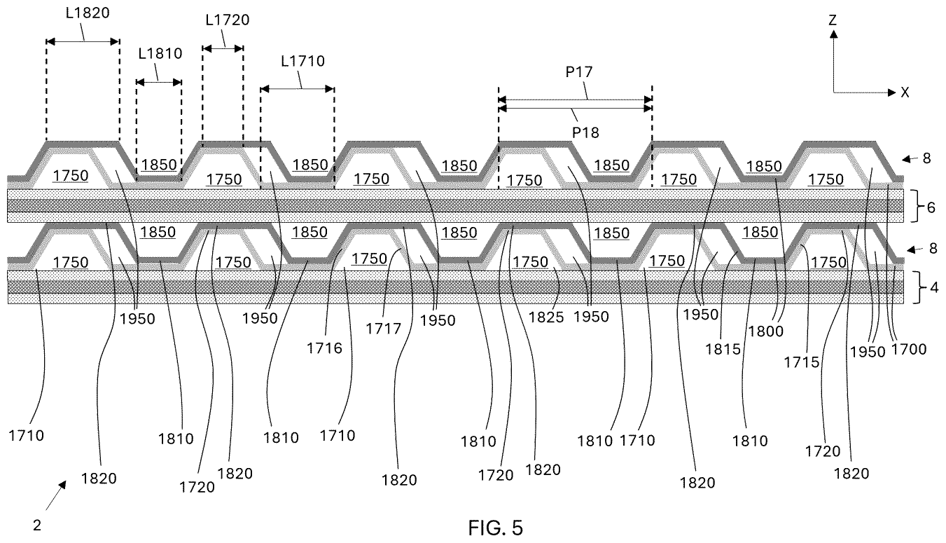

With reference to FIGS. 2-5, the bipolar plate assembly 8 of the fuel cell stack 2 includes two separate half plates 400 and 500 which are bonded together so as to define a coolant volume therebetween. FIG. 2 provides a plan view of the bipolar plate assembly 8, FIG. 3 provides a partial cross-sectional view of the bipolar plate assembly 8 located against the sides of adjacent membrane electrode assemblies 4 and 6 (with diffusion media not shown in the view of FIG. 3) according to an embodiment, FIG. 4 provides a partial cross-sectional view of the bipolar plate assembly 8 located against the sides of adjacent membrane electrode assemblies 4 and 6 (with diffusion media not shown in the view of FIG. 4) according to another embodiment, and FIG. 5 provides a partial cross-sectional view of the bipolar plate assembly 8 located against the sides of adjacent membrane electrode assemblies 4 and 6 (with diffusion media not shown in the view of FIG. 5) according to another embodiment.

FIG. 2 illustrates that the bipolar plate 8 (and each half plate 400 and 500) includes a central active area or region 130 and non-active areas, regions, or margins 140. The central active region 130 confronts the MEAs 4 and 6 (shown in FIG. 1) and is bounded by non-active areas 140. The central active region 130 has a width W1 (or height) in the Y-direction and has a lateral width L1 in the X-direction. In embodiments herein, the central active region 130 has a height/width (W1/L1) aspect ratio of from 0.8 to 4.0. For example, the aspect ratio may be at least 0.8, at least 0.9, at least 1.0, at least 1.1, at least 1.2, at least 1.3, at least 1.4, at least 1.5, at least 2.0, at least 2.5, at least 3.0, or at least 3.5 and may be at most 4.0, such as at most 3.5, at most 3.0, at most 2.5, at most 2.0, at most 1.5, at most 1.2, or at most 1.0. Such an aspect ratio provides for a greater number of flow channels, and provides each flow channel with a shorter flow distance, as compared to designs with a smaller aspect ratio.

As further shown, the non-active areas 140 and active region 130 are surrounded by a frame 150.

The anode half plate 400 has a working face with an anode flow field including a plurality of wavy flow channels for distributing hydrogen over the anode face of the MEA 4. Likewise, the cathode plate 500 has a working face with a cathode flow field including a plurality of wavy flow channels for distributing oxygen (often in the form of air) over the cathode face of the MEA 6. The active region 130 of the bipolar plate 8 is flanked by two inactive border portions or margins 141 and 142 that have openings 46, 48, 50, 52, 54, and 56 formed therethrough. When the anode and cathode plates 400, 500 are stacked together, the openings 46, 48, 50, 52, 54, and 56 in the plates 400 and 500 are aligned with like openings in adjacent bipolar plate assemblies. Other components of the fuel cell stack 2 such as gaskets 26, 28, 30 and 32 as well as the membrane of the MEAs 4 and 6 and the end plates 14 and 16 have corresponding openings that align with the openings in the bipolar plate assembly in the stack, and together form headers for supplying and removing gaseous reactants and liquid coolant to/from the stack.

In the embodiment shown in the figures, opening 46 in a series of stacked plates forms an air inlet header, opening 48 in series of stacked plates forms an air outlet header, opening 50 in a series of stacked plates forms a hydrogen inlet header, openings 52 in a series of stacked plates forms a hydrogen outlet header, opening 54 in a series of stacked plates forms a coolant inlet header, and opening 56 in a series of stacked plates forms a coolant outlet header. Inlet plumbing 58, 60 for both the oxygen/air and hydrogen may be in fluid communication with the inlet headers 46, 50 respectively. Likewise, exhaust plumbing 62, 64 for both the hydrogen and the oxygen/air may be in fluid communication with the exhaust headers 48, 52 respectively. Additional plumbing 66, 68 is provided for respectively supplying liquid coolant to and removing coolant from the coolant header 54, 56.

FIG. 3 is a partial cross-sectional view of a bipolar plate 8, taken along a portion of the active region 130.

In the active region 130, the anode half plate 400 is formed with a pattern or series of lands 410 and protrusions 420, and with ribs 415 interconnecting the lands 410 and protrusions 420. As shown, the lands 410 of anode half plate 400 contact the anode face of the underlying MEA 4 or 6. The protrusions 420 do not contact the MEAs 4 or 6. Rather, protrusions 420 are distanced from both MEA 4 and from MEA 6. Each rib 415 extends between and interconnects adjacent lands 410 and protrusions 420.

As shown, the anode half plate 400 has a repeating pattern of land 410, rib 415, protrusion 420, and rib 415. The repeating pattern has a period P4, pitch or cycle. The period P4 of the anode half plate 400 is the length of one complete cycle of the repeating pattern.

Further, the lands 410 are sufficiently wide to receive two lands of the cathode half plate 500 as described below. For example, each land 410 has a length L410 in the lateral X-direction. Each land 410 may directly contact the MEA 6 or 8 continuously along the entire length L410. Further, each protrusion 420 has a length L420 in the lateral X-direction.

In the active region 130, the cathode half plate 500 is formed with a pattern or series of lands 510 and protrusions 520, and with ribs 515 interconnecting the lands 510 and protrusions 520. As shown, the protrusions 520 of cathode half plates 500 contact the cathode face of the overlying MEAs 6. Each protrusion 520 has a length L520 in the lateral X-direction. Each protrusion 520 may directly contact the overlying MEAs 6 continuously along the entire length L520. As shown, the lands 510 of cathode half plates 500 contact the underlying anode half plate 400. Specifically, the lands 510 lie on the lands 410 of the anode half plate 400. Each land 510 has a length L510 in the lateral X-direction. Each land 510 may directly contact the land 410 of the underlying anode half plate 400 continuously along the entire length L510. Each rib 515 extends between and interconnects adjacent lands 510 and protrusions 520.

As shown, the cathode half plate 500 has a repeating pattern of land 510, rib 515, protrusion 520, and rib 515. The repeating pattern has a period P5, pitch or cycle. The period P5 of the cathode half plate 500 is the length of one complete cycle of the repeating pattern. In the embodiment of FIG. 3, pitch P5 is equal to half of pitch P4.

The period P5 and land length L510 are sufficiently low to repeatedly fit two lands 510 of the cathode half plate 500 on one land 410 of the anode half plate 400.

As shown, anode flow channels 450 are formed between and defined by the anode face of the underlying MEAs 4 and 6, protrusions 420, and the ribs 415 interconnecting the protrusions 420 to the lands 410. The anode flow channels 450 may distribute hydrogen over the anode face of the MEAs.

As shown, cathode flow channels 550 are formed between and defined by the cathode face of the overlying MEAs 4 and 6, lands 510, and the ribs 515 interconnecting the lands 510 to the protrusions 520. The cathode flow channels 550 may distribute oxygen, such as in the form of air, over the cathode face of the MEAs.

As shown, coolant flow channels 650 are formed between and defined by the anode half plate 400 and the cathode half plate 500. Specifically, coolant flow channels 650 are formed between lands 410 of the anode half plate 400 and the protrusions 520 and ribs 515 of the cathode half plate 500.

It is noted that alternate protrusions 520 of the cathode half plate 500 serve different purposes. For example, the protrusions 520 may include primary protrusions 521 and secondary protrusions 522 that alternate. The primary protrusions 521 enclose the coolant flow channels 650. The secondary protrusions 522 lie over the anode flow channels 450. More specifically, each secondary protrusion 522 encloses a gap 525 in which a respective protrusion 420 of the anode half plate 400 is received and forms a respective anode flow channel 450.

In the embodiment of FIG. 3, the anode flow channels 450 are centered in the gaps 525, the protrusions 420 of the anode half plate 400 do not contact the protrusions 520 of the cathode half plate 500, and the ribs 415 do not contact the ribs 515.

FIG. 4 illustrates an alternative embodiment of the fuel cell stack 2.

FIG. 4 is a partial cross-sectional view of a bipolar plate 8, taken along a portion of the active region 130.

In the active region 130, an anode half plate 700 is formed with a pattern or series of lands 710 and protrusions 720, and with ribs 715 interconnecting the lands 710 and protrusions 720. As shown, the lands 710 of anode half plate 700 contact the anode face of the underlying MEA 4 or 6. The protrusions 720 do not contact the MEAs 4 or 6. Rather, protrusions 720 are distanced from both MEA 4 and from MEA 6. Each rib 715 extends between and interconnects adjacent lands 710 and protrusions 720.

As shown, the anode half plate 700 has a repeating pattern of land 710, rib 715, protrusion 720, and rib 715. The repeating pattern has a period P7, pitch or cycle. The period P7 of the anode half plate 700 is the length of one complete cycle of the repeating pattern.

Further, the lands 710 are sufficiently wide to receive two lands of the cathode half plate 800 as described below. For example, each land 710 has a length L710 in the lateral X-direction. Each land 710 may directly contact the MEA 6 or 8 continuously along the entire length L710. Further, each protrusion 720 has a length L720 in the lateral X-direction.

In the active region 130, the cathode half plate 800 is formed with a pattern or series of lands 810 and protrusions 820, and with ribs 815 interconnecting the lands 810 and protrusions 820. As shown, the protrusions 820 of cathode half plates 800 contact the cathode face of the overlying MEAs 6. Each protrusion 820 has a length L820 in the lateral X-direction. Each protrusion 820 may directly contact the overlying MEAs 6 continuously along the entire length L820. As shown, the lands 810 of cathode half plates 800 contact the underlying anode half plate 700. Specifically, the lands 810 lie on the lands 710 of the anode half plate 700. Each land 810 has a length L810 in the lateral X-direction. Each land 810 may directly contact the land 710 of the underlying anode half plate 700 continuously along the entire length L810. Each rib 815 extends between and interconnects adjacent lands 810 and protrusions 820.

As shown, the cathode half plate 800 has a repeating pattern of land 810, rib 815, protrusion 820, and rib 815. The repeating pattern has a period P8, pitch or cycle. The period P8 of the cathode half plate 800 is the length of one complete cycle of the repeating pattern. In the embodiment of FIG. 4, pitch P8 is equal to half of pitch P7.

The period P8 and land length L810 are sufficiently low to repeatedly fit two lands 810 of the cathode half plate 800 on one land 710 of the anode half plate 700.

As shown, anode flow channels 750 are formed between and defined by the anode face of the underlying MEAs 4 and 6, protrusions 720, and the ribs 715 interconnecting the protrusions 720 to the lands 710. The anode flow channels 750 may distribute hydrogen over the anode face of the MEAs.

As shown, cathode flow channels 850 are formed between and defined by the cathode face of the overlying MEAs 4 and 6, lands 810, and the ribs 815 interconnecting the lands 810 to the protrusions 820. The cathode flow channels 850 may distribute oxygen, such as in the form of air, over the cathode face of the MEAs.

As shown, coolant flow channels 950 are formed between and defined by the anode half plate 700 and the cathode half plate 800. Specifically, coolant flow channels 950 are formed between lands 710 of the anode half plate 700 and the protrusions 820 and ribs 815 of the cathode half plate 800.

It is noted that alternate protrusions 820 of the cathode half plate 800 serve different purposes. For example, the protrusions 820 may include primary protrusions 821 and secondary protrusions 822 that alternate. The primary protrusions 821 enclose the coolant flow channels 950. The secondary protrusions 822 lie over the anode flow channels 750. More specifically, each secondary protrusion 822 encloses a gap 825 in which a respective protrusion 720 of the anode half plate 700 is received and forms a respective anode flow channel 750.

In the embodiment of FIG. 4, the anode flow channels 750 are not centered in the gaps 825. Rather, alternating ribs 715 of the anode half plate 700 contact ribs 815 of the cathode half plate 800. For example, the ribs 715 may include primary ribs 716 and secondary ribs 717 that alternate. Primary ribs 716 contact ribs 815, while secondary ribs 717 do not contact ribs 815. Thus, additional coolant flow channels 950 may be formed between the lands 710 and secondary ribs 717 of the anode half plate 400 and the protrusions 820 and ribs 815 of the cathode half plate 800.

Further, in the embodiment of FIG. 4, the protrusions 720 may directly contact the protrusions 820. For example, the protrusions 720 may continuously contact the protrusions 820 along the entirety of length L720.

FIG. 5 illustrates an alternative embodiment of the fuel cell stack 2.

FIG. 5 is a partial cross-sectional view of a bipolar plate 8, taken along a portion of the active region 130.

In the active region 130, an anode half plate 1700 is formed with a pattern or series of lands 1710 and protrusions 1720, and with ribs 1715 interconnecting the lands 1710 and protrusions 1720. As shown, the lands 1710 of anode half plate 1700 contact the anode face of the underlying MEA 4 or 6. The protrusions 1720 do not contact the MEAs 4 or 6. Rather, protrusions 1720 are distanced from both MEA 4 and from MEA 6. Each rib 1715 extends between and interconnects adjacent lands 1710 and protrusions 1720.

As shown, the anode half plate 1700 has a repeating pattern of land 1710, rib 1715, protrusion 1720, and rib 1715. The repeating pattern has a period P17, pitch or cycle. The period P17 of the anode half plate 1700 is the length of one complete cycle of the repeating pattern.

Further, the lands 1710 are sufficiently wide to receive a single land cathode half plate 1800 as described below. For example, each land 1710 has a length L1710 in the lateral X-direction. Each land 1710 may directly contact the MEA 6 or 8 continuously along the entire length L1710. Further, each protrusion 1720 has a length L1720 in the lateral X-direction.

In the active region 130, the cathode half plate 1800 is formed with a pattern or series of lands 1810 and protrusions 1820, and with ribs 1815 interconnecting the lands 1810 and protrusions 1820. As shown, the protrusions 1820 of cathode half plates 1800 contact the cathode face of the overlying MEAs 6. Each protrusion 1820 has a length L1820 in the lateral X-direction. Each protrusion 1820 may directly contact the overlying MEAs 6 continuously along the entire length L1820. As shown, the lands 1810 of cathode half plates 1800 contact the underlying anode half plate 1700. Specifically, the lands 1810 lie on the lands 1710 of the anode half plate 1700. Each land 1810 has a length L1810 in the lateral X-direction. Each land 1810 may directly contact the land 1710 of the underlying anode half plate 1700 continuously along the entire length L1810. Each rib 1815 extends between and interconnects adjacent lands 1810 and protrusions 1820.

As shown, the cathode half plate 1800 has a repeating pattern of land 1810, rib 1815, protrusion 1820, and rib 1815. The repeating pattern has a period P18, pitch or cycle. The period P18 of the cathode half plate 1800 is the length of one complete cycle of the repeating pattern. In the embodiment of FIG. 4, pitch P8 is equal to pitch P7.

As shown, anode flow channels 1750 are formed between and defined by the anode face of the underlying MEAs 4 and 6, protrusions 1720, and the ribs 1715 interconnecting the protrusions 1720 to the lands 1710. The anode flow channels 1750 may distribute hydrogen over the anode face of the MEAs.

As shown, cathode flow channels 1850 are formed between and defined by the cathode face of the overlying MEAs 4 and 6, lands 1810, and the ribs 1815 interconnecting the lands 1810 to the protrusions 1820. The cathode flow channels 1850 may distribute oxygen, such as in the form of air, over the cathode face of the MEAs.

In the embodiment of FIG. 5, the anode flow channels 1750 are not centered in the gaps 1825. Rather, alternating ribs 1715 of the anode half plate 1700 contact ribs 1815 of the cathode half plate 1800. For example, the ribs 1715 may include primary ribs 1716 and secondary ribs 1717 that alternate. Primary ribs 1716 contact ribs 1815, while secondary ribs 1717 do not contact ribs 1815. Thus, coolant flow channels 1950 are formed between the lands 1710 and secondary ribs 1717 of the anode half plate 1700 and the protrusions 1820 and ribs 1815 of the cathode half plate 1800. More generally, the coolant flow channels 1950 are formed between and defined by the anode half plate 1700 and the cathode half plate 1800.

Further, in the embodiment of FIG. 5, the protrusions 1720 may directly contact the protrusions 1820. For example, the protrusions 1720 may continuously contact the protrusions 1820 along the entirety of length L1720.

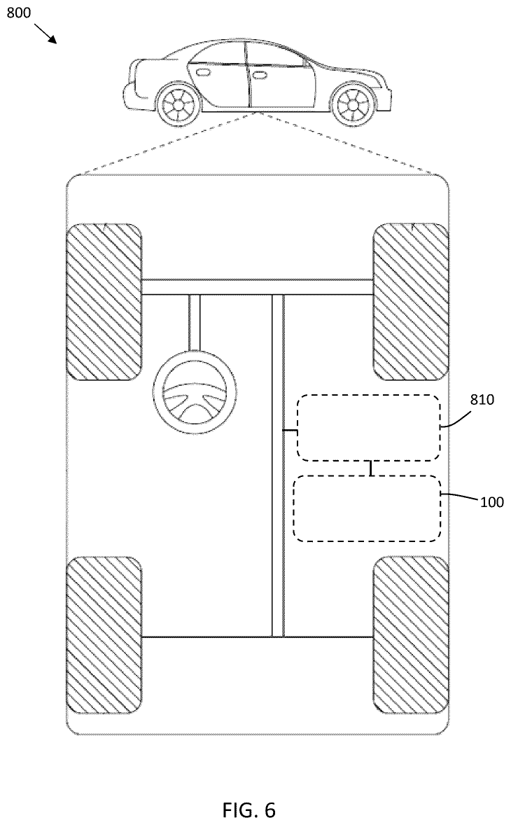

FIG. 6 is a schematic illustrating a device 800 including a fuel cell 100, such as the fuel cell stack 2 of FIG. 1. FIG. 6 illustrates the device 800 as a vehicle, such as an electric vehicle like an automobile, including any one of a number of different types of automobiles, such as, for example, a sedan, a wagon, a truck, sport utility vehicle (SUV), or the like. In certain implementations, the device 800 may include a motorcycle or other land-based vehicle, such as a rail locomotive, or a non-land-based vehicle such as aircraft, spacecraft, watercraft, and so on, and/or one or more other types of mobile platforms (e.g., a robot and/or another mobile platform). In yet other implementations, the device 800 may instead be part of and/or coupled to any number of other types of platforms and/or other systems, moving or non-moving, such as a building, infrastructure, secondary use, home power, non-automotive, and/or other platforms and/or other systems.

The illustrated device 800 includes a battery module 810 for storing electricity. As shown, the battery module 810 is operatively connected to the fuel cell 100. The battery module 810 may be charged by the fuel cell 100.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing summary and detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A fuel cell, comprising:
a first membrane electrode assembly (MEA) and a second membrane electrode assembly (MEA), wherein each MEA has an anode side and a cathode side;
a bipolar composite plate assembly located between the anode side of the first MEA and the cathode side of the second MEA, the bipolar composite plate assembly comprising:
a first composite sub-plate comprising:
first lands located against the anode side of the first MEA;
first protrusions located at a distance from the anode side of the first MEA; and
first ribs interconnecting the first lands and first protrusions;
wherein first flow channels open to the anode side of the first MEA are defined between the first MEA and the first protrusions; and
a second composite sub-plate comprising:
second lands located against the first lands;
second protrusions located against the cathode side of the second MEA; and
second ribs interconnecting the second lands and second protrusions;
wherein second flow channels open to the cathode side of the second MEA are defined between the second MEA and the second lands; and
wherein the first composite sub-plate and the second composite sub-plate are nested together to form coolant flow channels between the first lands and the second protrusions.

2. The fuel cell of claim 1, wherein:
each composite sub-plate has a web thickness of from 0.1 mm to 0.4 mm.

3. The fuel cell of claim 2, wherein:
each composite sub-plate is formed from carbon and resin and is compression molded.

4. The fuel cell of claim 2, wherein:
each composite sub-plate is formed from a flexible graphite material molded and filled with resin.

5. The fuel cell of claim 2, wherein:
each composite sub-plate is reinforced with conductive carbon fibers.

6. The fuel cell of claim 1, wherein:
the bipolar composite plate assembly forms a flow field having a first edge facing headers for flowing hydrogen, oxygen, and/or coolant and having a second edge sealed to a frame; and
an aspect ratio of the first edge to the second edge is from 0.8 to 4.0.

7. The fuel cell of claim 1, wherein:
the second protrusions include primary second protrusions alternating with secondary second protrusions;
the coolant flow channels are defined between the first lands and the primary second protrusions; and
the first flow channels are defined between the first MEA and the secondary second protrusions.

8. The fuel cell of claim 7, wherein:
the bipolar composite plate assembly extends in a lateral direction; and
the primary second protrusions and the secondary second protrusions have a same second length in the lateral direction.

9. The fuel cell of claim 8, wherein:
the first composite sub-plate has a first repeating pattern of first lands, first protrusions, and first ribs;
the first repeating pattern has a first period;
the second composite sub-plate has a second repeating pattern of second lands, second protrusions, and second ribs;
the second repeating pattern has a second period; and
the second period is equal to half of the first period.

10. The fuel cell of claim 9, wherein:
the first protrusions are located between the first MEA and the secondary second protrusions; and
the first protrusions are spaced from and do not contact the secondary second protrusions.

11. The fuel cell of claim 10, wherein:
the first ribs are spaced from and do not contact the second ribs.

12. The fuel cell of claim 11, wherein:
the first composite sub-plate and the second composite sub-plate contact each other at contact interfaces; and
the contact interfaces are only located between the first lands and the second lands.

13. The fuel cell of claim 9, wherein:
the first protrusions have a first length in the lateral direction;
the first protrusions are located between the first MEA and the secondary second protrusions; and
the first protrusions contact the secondary second protrusions along an entirety of the first length.

14. The fuel cell of claim 13, wherein:
the first ribs include primary first ribs and secondary first ribs alternating with the primary first ribs;
the primary first ribs contact the second ribs; and
the secondary first ribs are spaced from and do not contact the second ribs.

15. The fuel cell of claim 1, wherein:
the first composite sub-plate has a first repeating pattern of first lands, first protrusions, and first ribs;
the first repeating pattern has a first period;
the second composite sub-plate has a second repeating pattern of second lands, second protrusions, and second ribs;
the second repeating pattern has a second period; and
the second period is equal to the first period.

16. The fuel cell of claim 15, wherein:
the bipolar composite plate assembly extends in a lateral direction;
the first protrusions have a first length in the lateral direction;
the first protrusions are located between the first MEA and the second protrusions; and
the first protrusions contact the second protrusions along an entirety of the first length.

17. The fuel cell of claim 16, wherein:
the first ribs include primary first ribs and secondary first ribs alternating with the primary first ribs;
the primary first ribs contact the second ribs;
the secondary first ribs are spaced from and do not contact the second ribs; and
each coolant flow channel is defined between a respective secondary first rib and a respective second rib.

18. A device comprising:
a battery configured to store electricity; and
a fuel cell electrically connected to the battery, wherein the fuel cell comprises:
a first membrane electrode assembly (MEA) and a second membrane electrode assembly (MEA), wherein each MEA has an anode side and a cathode side;
a bipolar composite plate assembly located between the anode side of the first MEA and the cathode side of the second MEA, the bipolar composite plate assembly comprising:
a first composite sub-plate comprising:
first lands located against the anode side of the first MEA;
first protrusions located at a distance from the anode side of the first MEA; and
first ribs interconnecting the first lands and first protrusions; and
a second composite sub-plate comprising:
second lands located against the first lands;
second protrusions located against the cathode side of the second MEA; and
second ribs interconnecting the second lands and second protrusions;
wherein:
each composite sub-plate has a web thickness of from 0.1 mm to 0.4 mm;
the first composite sub-plate and the second composite sub-plate are nested together to form coolant flow channels between the first lands and the second protrusions;
first flow channels open to the anode side of the first MEA are defined between the first MEA and the first protrusions;
second flow channels open to the cathode side of the second MEA are defined between the second MEA and the second lands; and
the first composite sub-plate has a first repeating pattern of first lands, first protrusions, and first ribs;
the first repeating pattern has a first period;
the second composite sub-plate has a second repeating pattern of second lands, second protrusions, and second ribs;
the second repeating pattern has a second period; and
the second period is equal to half of the first period.

19. The device of claim 18, wherein:
the bipolar composite plate assembly forms a flow field having a first edge facing headers for flowing hydrogen, oxygen, and/or coolant and having a second edge sealed to a frame; and
an aspect ratio of the first edge to the second edge is from 0.8 to 4.0.

20. A method for forming a fuel cell, the method comprising:
providing a first membrane electrode assembly (MEA) and a second membrane electrode assembly (MEA), wherein each MEA has an anode side and a cathode side; and
forming a bipolar composite plate from a first composite sub-plate and a second composite sub-plate, wherein the first composite sub-plate comprises first lands, first protrusions, and first ribs interconnecting the first lands and first protrusions, and wherein the second composite sub-plate comprises second lands, second protrusions, and second ribs interconnecting the second lands and second protrusions, by nesting together the first composite sub-plate and the second composite sub-plate to form coolant flow channels between the first lands and the second protrusions, to locate the first lands located against the anode side of the first MEA, to locate the first protrusions at a distance from the anode side of the first MEA, to locate the second lands against the first lands, to locate the second protrusions against the cathode side of the second MEA, to define first flow channels open to the anode side of the first MEA between the first MEA and the first protrusions, and to define second flow channels open to the cathode side of the second MEA between the second MEA and the second lands.
